(19) United States
(12) Patent Application Publication
(10) Pub. No.: US 2016/0071455 A1
(43) Pub. Date: Mar. 10, 2016

(54) DISPLAY DRIVER AND DISPLAY METHOD

(71) Applicants: Hye-Jin JUNG, Hwaseong-si (KR); Hyun-Sang PARK, Seongnam-si (KR); Kyung-Chun KIM, Yongin-si (KR)

(72) Inventors: Hye-Jin JUNG, Hwaseong-si (KR); Hyun-Sang PARK, Seongnam-si (KR); Kyung-Chun KIM, Yongin-si (KR)

(21) Appl. No.: 14/743,044

(22) Filed: Jun. 18, 2015

(30) Foreign Application Priority Data
Sep. 5, 2014 (KR) 10-2014-0119234

(51) Int. Cl. G09G 3/20

(52) U.S. Cl. CPC G09G 3/2096; G09G 2310/06; G09G 2310/0254

(57) ABSTRACT

A display driver and display method are provided. The display driver includes a line buffer which receives a plurality of first pixel data corresponding to a first line, and a controller which receives a plurality of second pixel data corresponding to a second line that is different from the first line. The controller also receives the first pixel data from the line buffer, classifies the second pixel data into a plurality of transition types based on the first pixel data and the second pixel data, calculates one or more characteristic values indicating characteristics of each transition type, and determines whether to perform charge sharing of channels based on the characteristic values.

This application claims priority from Korean Patent Application No. 10-2014-0119234, filed on Sep. 5, 2014, in the Korean Intellectual Property Office, the disclosure of which is incorporated herein by reference in its entirety.

### BACKGROUND

1. Field

Apparatuses and methods consistent with exemplary embodiments relate to a display driver and a display method.

2. Description of the Related Art

A display driver IC (DDI) is an integrated circuit that may be designed to control a display subsystem in various terminals such as mobile phones, desktop and laptop computers, digital TV receivers, tablets, external Organic Light-Emitting Diode (OLED) display panels, and the like.

As development increases the portability of various electronic products and reduces the size of the electronic products, many changes are being required of a Display Driving IC that drives a display panel. For example, to increase portability, electronic products may use batteries as their power source. However, the power consumption of the DDI consumes a great amount of power and therefore should be reduced.

### SUMMARY

Aspects of the exemplary embodiment provide a display driver with low power consumption. In addition, one or more exemplary embodiments provide a display method which requires low power consumption.

It should also be appreciated that aspects of the present inventive concept are not restricted to the examples set forth herein. For example, the above and other aspects of the present inventive concept will become more apparent to one of ordinary skill in the art to which the present inventive concept pertains by referencing the detailed description provided below.

According to an aspect of an exemplary embodiment, there is provided a display driver including a line buffer configured to receive a plurality of first pixel data corresponding to a first line, and a controller configured to receive a plurality of second pixel data corresponding to a second line that is different from the first line, receive the first pixel data from the line buffer, classify the second pixel data into a plurality of transition types based on the first pixel data and the second pixel data, calculate one or more characteristic values indicating characteristics of each transition type, and determine whether to perform charge sharing of channels based on the characteristic values.

According to an aspect of another exemplary embodiment, there is provided a display driver including a line buffer configured to receive a plurality of first pixel data corresponding to a first line, and a controller configured to receive a plurality of second pixel data corresponding to a second line that is different from the first line, receive the first pixel data from the line buffer, classify the second pixel data into a plurality of transition types, which include a first rising type of a first polarity, a first falling type of the first polarity, a second rising type of a second polarity and a second falling type of the second polarity, based on the first pixel data and the second pixel data, perform charge sharing of a plurality of channels corresponding to the first polarity in response to a first transition value of the first rising type of the first polarity being greater than a first reference value and in response to a second transition value of the first falling type of the first polarity being greater than a second reference value, and perform charge sharing of a plurality of channels corresponding to the second polarity in response to a third transition value of the second rising type of the second polarity being greater than a third reference value and in response to a fourth transition value of the second falling type of the second polarity being greater than a fourth reference value.

According to an aspect of another exemplary embodiment, there is provided a display method including classifying a plurality of second pixel data into a plurality of transition types based on a plurality of first pixel data corresponding to a first line and the second pixel data corresponding to a second line different from the first line, calculating one or more characteristic values indicating characteristics of each transition type, and determining whether to perform charge sharing of channels based on the characteristic values.

### BRIEF DESCRIPTION OF THE DRAWINGS

The above and other aspects and features will become more apparent by describing the exemplary embodiments with reference to the attached drawings, in which:

FIG. 1 is a block diagram of a display device according to an exemplary embodiment;

FIG. 2 is a conceptual diagram of a display panel illustrated in FIG. 1 according to an exemplary embodiment;

FIG. 3 is a conceptual diagram illustrating data that may be input to the display panel of FIG. 2 according to an exemplary embodiment;

FIG. 4 is a block diagram of a driving controller illustrated in FIG. 1 according to an exemplary embodiment;

FIG. 5 is a block diagram of a source driver illustrated in FIG. 1 according to an exemplary embodiment;

FIG. 6 is a block diagram of a charge sharing controller illustrated in FIG. 5 according to an exemplary embodiment;

FIG. 7 is an exemplary circuit diagram of a buffer circuit and a charge sharing circuit illustrated in FIG. 5 according to an exemplary embodiment;

FIG. 8 is a flowchart illustrating a display method according to an exemplary embodiment;

FIG. 9 is a conceptual diagram illustrating transition types according to an exemplary embodiment;

FIGS. 10 through 13 are conceptual diagrams illustrating a method of determining whether to perform charge sharing according to exemplary embodiments;

FIG. 14 is a flowchart illustrating a display method according to an exemplary embodiment;

FIG. 15 is a timing diagram illustrating a display method according to another exemplary embodiment;

FIG. 16 illustrates a display module according to an exemplary embodiment;

FIG. 17 illustrates a display system according to an exemplary embodiment; and

FIG. 18 illustrates various examples of an electronic product loaded with a display device according to an exemplary embodiment.

### DETAILED DESCRIPTION

Advantages and features of the inventive concept and methods of accomplishing the same may be understood more readily by reference to the following detailed description of exemplary embodiments and the accompanying drawings. The inventive concept may, however, be embodied in many different forms and should not be construed as being limited to the embodiments set forth herein. Rather, these exemplary embodiments are provided so that this disclosure will be thorough and complete and will fully convey the inventive concept to those skilled in the art, and the present inventive concept will only be defined by the appended claims. Herein, like reference numerals refer to like elements throughout the specification.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it may be directly on, connected or coupled to the other element or layer or intervening elements or layers may also be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, and the like, may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath”, “below”, “lower”, “above”, “upper”, and the like, may be used herein for ease of description to describe an element or a feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Exemplary embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but may include deviations in shapes that result, for example, from manufacturing. For example, an implanted region illustrated as a rectangle will, typically, have rounded or curved features and/or a gradient of implant concentration at its edges rather than a binary change from an implanted to a non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which the present inventive concept belongs. It will also be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

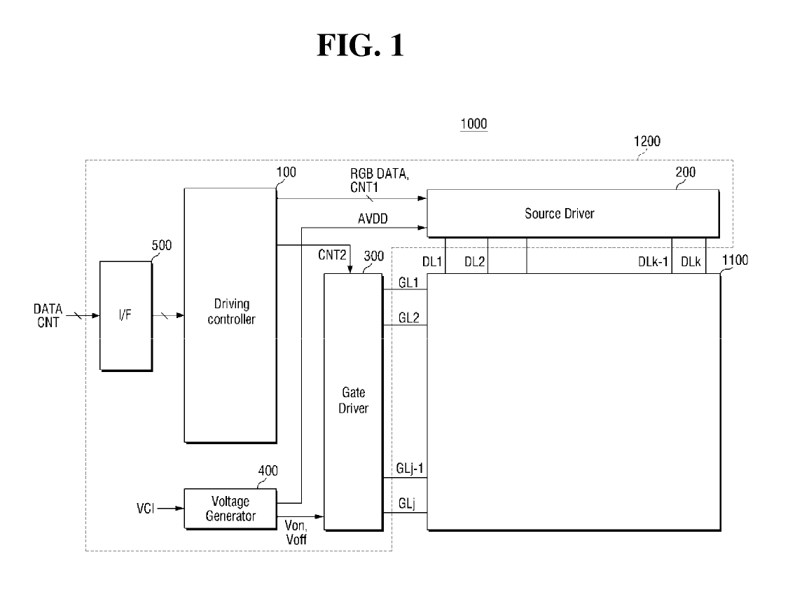

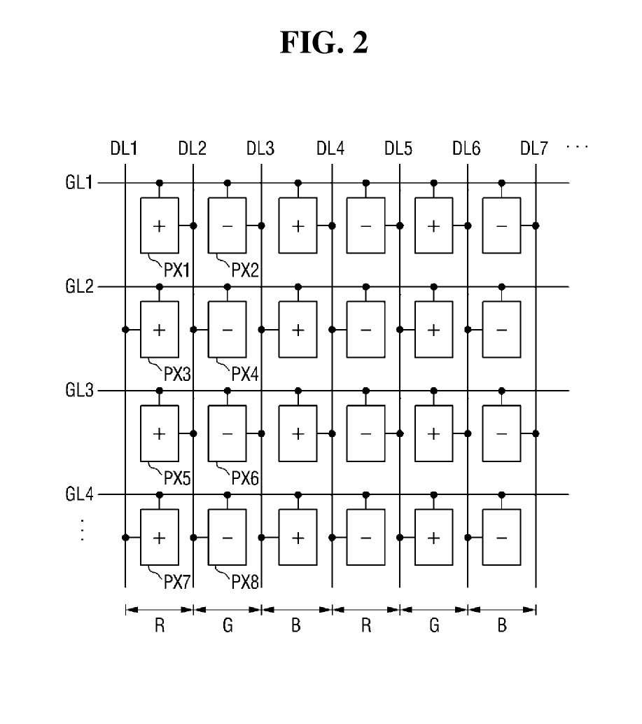

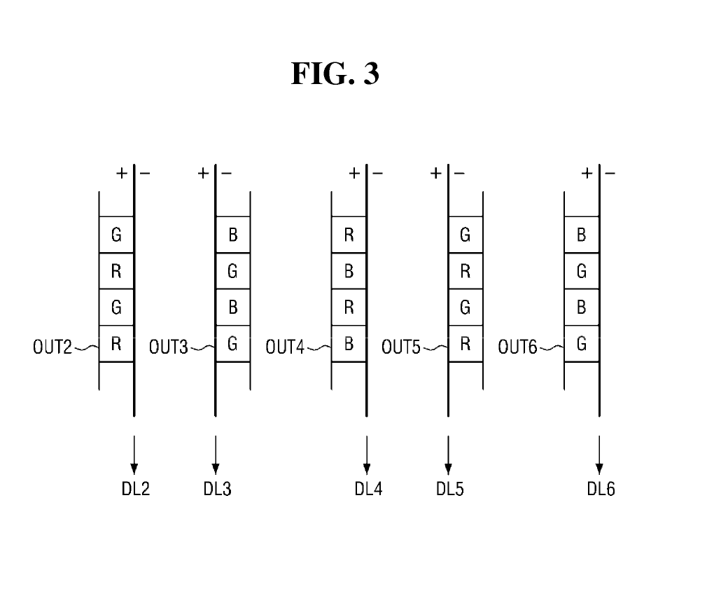

FIG. 1 is a block diagram of a display device 1000 according to an exemplary embodiment. FIG. 2 is a conceptual diagram of a display panel 1100 illustrated in FIG. 1 according to an exemplary embodiment. FIG. 3 is a conceptual diagram illustrating the form of data input to the display panel 1100 of FIG. 2 according to an exemplary embodiment.

Referring to FIG. 1, the display device 1000 includes a display panel 1100 and a display driver circuit 1200 which drives the display panel 1100 based on video data (DATA) and a control signal (CNT) which are received.

The display device 1000 may be any one of various display devices, for example, an organic light-emitting diode display (OLED), a liquid crystal display (LCD), an electrochromic display (ECD), a digital mirror device (DMD), an actuated mirror device (AMD), a grating light value (GLV), a plasma display panel (PDP), an electroluminescent display (ELD), and the like.

In this example, the display panel 1100 includes a plurality of gate lines GL1 through GLj (where j is a natural number greater than one) which deliver scan signals in a row direction. The display panel 1100 also includes a plurality of data lines DL1 through DLk (where k is a natural number greater than one) which are arranged in a direction intersecting the gate lines GL1 through GLj and which deliver data signals in a column direction. The display panel 1100 also includes a plurality of pixels PX which are disposed at intersections of the gate lines GL1 through GLj and the data lines DL1 through DLk.

When the gate lines GL1 through GLj are sequentially selected, gray voltages Vg are applied to pixels PX that are connected to a selected gate line via the data lines DL1 through DLk.

In this example, the display driver circuit 1200 includes a driving controller 100, a source driver 200, a gate driver 300, a voltage generator 400, and an interface (I/F) circuit 500.

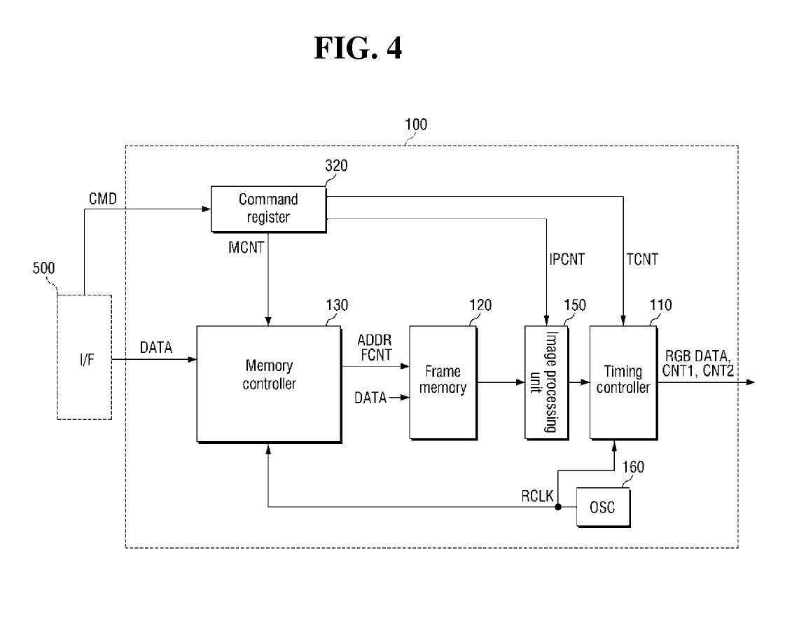

The driving controller 100 receives the video data DATA and the control signal CNT from an external source, for example, a host of a system that is loaded with the display device 1000. The driving controller 100 provides control signals CNT1 and CNT2 for the operation of the source driver 200 and the gate driver 300 and pixel data RGB DATA to the source driver 200 and the gate driver 300. For example, the driving controller 100 may include a timing controller, an image processing unit, a frame memory, a memory controller, a command register, and the like. An example of a configuration of the driving controller 100 is described with reference to FIG. 4.

The source driver 200 converts the pixel data RGB DATA (which is digital data) received from the driving controller 100 into gray voltages (i.e., data voltages) and outputs the gray voltages to the data lines DL1 through DLk of the display panel 1100. For example, the gate driver 300 may sequentially scan the gate lines GL1 through GLj of the display panel 1100. The gate driver 300 activates a selected gate line by applying a gate-on voltage (Von) to the selected gate line, and the source driver 200 outputs gray voltages corresponding to pixels that are connected to the activated gate line. Accordingly, the display panel 1100 may display an image on a horizontal line-by-horizontal line basis, for example, on a row-by-row basis.

The voltage generator 400 receives a power supply voltage VCI from an external source and generates voltages (AVDD, Von, Voff) for use by the source driver 200 and the gate driver 300.

The interface circuit 500 may be designed for communication with a host (e.g., an application processor). The interface circuit 500 may receive the video data DATA and the control signal CNT in parallel or in series from the host and provide the video data DATA and the control signal CNT to the driving controller 100. The video data DATA and the control signal CNT may be transmitted from the host of the system loaded with the display device 1000. For example, the interface circuit 500 may receive the video data DATA and the control signal CNT using an interface method corresponding to a transmission method of the host. As an example, the interface method used by the interface circuit 500 may be one of an RGB interface method, a CPU interface method, a service provider interface (PSI) method, a mobile display digital interface (MDDI) method, a mobile industry processor interface (MIPI) method, and the like.

The display driver circuit 1200 may be implemented in the form of a display integrated circuit (IC) chip. If the display driver circuit 1200 is implemented in the form of an IC chip, the driving controller 100 and the drivers 200 and 300 can communicate with one another without transmitting signals/data in the form of packets at high speed. As another example, the driving controller 100, the source driver 200, and the gate driver 300 may be implemented as separate IC chips.

Referring to FIG. 2, the pixel arrangement of the display panel 1100 is as follows. A plurality of pixels (e.g., PX1, PX4, PX5 and PX8) connected to one data line (e.g., DL2) may correspond to a plurality of colors. For example, some (PX1 and PX5) of the pixels may correspond to red, and the other pixels (PX4 and PX8) may correspond to green.

To put it another way, a plurality of pixels (e.g., PX1, PX3, PX5 and PX7) corresponding to one color (e.g., red) may be connected to a plurality of data lines (e.g., DL1 and DL2). For example, some (PX1 and PX5) of the pixels may be connected to one (e.g., DL2) of the data lines, and the other pixels (PX3 and P7) may be connected to the other data line (e.g., DL1).

In addition, the display panel 1100 may perform a zigzag inversion. For example, in a first frame, a plurality of pixels PX1, PX4, PX5 and PX8 connected to one data line DL2 may have one polarity (e.g., a positive polarity (+)). In a second frame that is immediately following the first frame, the pixels PX1, PX4, PX5 and PX8 connected to the data line DL2 may have a different polarity (e.g., a negative polarity (−)). In this example, the polarity of the pixels PX1, PX4, PX5 and PX8 may be changed whenever the frame is changed.

Examples of data voltages OUT2 through OUT6 provided to the pixel arrangement of FIG. 2 may be as illustrated in FIG. 3.

For example, the data voltage OUT2 may include red corresponding to the pixel PX1 (or the gate line GL1), green corresponding to the pixel PX4 (or the gate line GL2), red corresponding to the pixel PX5 (or the gate line GL3), and green corresponding to the pixel PX8 (or the gate line GL4). In this example, the data voltage OUT2 may be input to the data line DL2 in an order of red, green, red and green of the positive polarity.

Likewise, the data voltage OUT3 may be provided in an order of green, blue, green and blue of the negative polarity. The data voltage OUT4 may be provided in an order of blue, red, blue and red of the positive polarity. The data voltage OUT5 may be provided in an order of red, green, red and green of the negative polarity. The data voltage OUT6 may be provided in an order of green, blue, green and blue of the positive polarity.

FIG. 4 is a block diagram of the driving controller 100 illustrated in FIG. 1 according to an exemplary embodiment.

Referring to FIG. 4, the driving controller 100 includes a timing controller 110, a frame memory 120, a memory controller 130, a command register 320, an image processing unit 150, and an oscillator 160.

The command register 320 stores a command signal CMD received from the interface circuit 500. For example, the command signal CMD may be a value for appropriately setting a driving circuit according to the display driving environment and may be set to various values according to a resolution of a display panel, an image signal processing method, and the like. The command register 320 generates signals (MCNT, IPCNT, TCNT) for controlling the memory controller 130, the image processing unit 150 and the timing controller 110, based on the command signal CMD, and provides the generated signals to the above circuits.

The timing controller 110 generates the control signals CNT1 and CNT2 for controlling the source driver 200 and the gate driver 300. Here, each of the control signals CNT1 and CNT2 may include a timing signal.

The frame memory 120 temporarily stores one frame of the video data DATA to be displayed on the display panel 1100 and outputs the frame of the video data DATA such that the frame is displayed on the display panel 1100. The frame memory 120 may also be referred to as a graphic random access memory (RAM), and a volatile memory such as a static random access memory (SRAM) can be used as the frame memory 120. However, the exemplary embodiments are not limited thereto, and various types of memories can be used.

The memory controller 130 may control the overall operation of the frame memory 120. For example, the memory controller 130 may control the address and timing at which a write operation and a scan operation are performed on the frame memory 120.

The image processing unit 150 converts the video data DATA received from the frame memory 120 into a value appropriate for the environment of the display panel 1100 (see FIG. 1) based on a control signal IPCNT, and transmits the value to the timing controller 110.

The oscillator 160 generates a reference clock RCLK and provides the reference clock RCLK to the timing controller 110 and the memory controller 130.

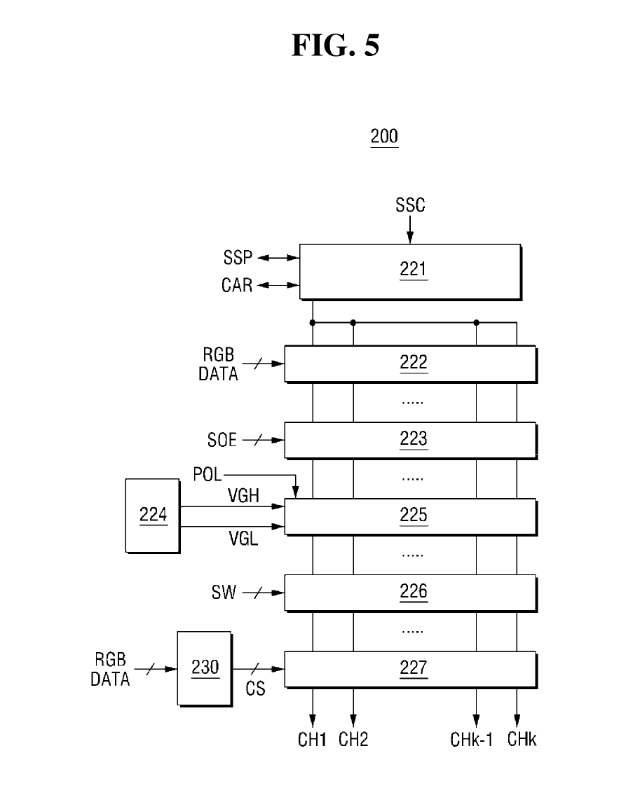

FIG. 5 is a block diagram of the source driver 200 illustrated in FIG. 1 according to an exemplary embodiment.

Referring to FIG. 5, the source driver 200 includes a shift register 221, a first latch array 222, a second latch array 223, a gamma compensation voltage generator 224, a digital-analog converter (DAC) 225, a buffer circuit 226, a charge sharing circuit 227, and a charge sharing controller 230.

The shifter register 221 shifts a sampling signal according to a source sampling clock SSC. In addition, the shift register 221 generates a carry signal (Carry) when data exceeding the number of latches of the first latch array 222 is supplied.

The first latch array 222 samples a plurality of pixel data RGB DATA received from the timing controller 110 (see FIG. 4) in response to sampling signals that are sequentially received from the shift register 221, latches the pixel data RGB DATA on a horizontal line-by-horizontal line basis, and simultaneously outputs each horizontal line of the pixel data RGB DATA.

The second latch array 223 latches one horizontal line of data received from the first latch array 222. Next, the second latch array 223 outputs the pixel data RGB DATA at the same time as the second latch arrays 223 of other data driver ICs during a logic low period of a source output enable signal (SOE).

The gamma compensation voltage generator 224 divides a plurality of gamma reference voltages into a number of gamma reference voltages that are equal to the number of gray levels that can be expressed by a bit number of the pixel data RGB DATA. By dividing the gamma reference voltages, the gamma compensation voltage generator 224 generates positive gamma compensation voltages (VGH) and negative gamma compensation voltages (VGL) corresponding to each gray level.

The DAC 225 includes a positive polarity decoder to which the positive gamma compensation voltages VGH are supplied, a negative polarity decoder to which the negative gamma compensation voltages VGL are supplied, and a multiplexer which selects an output of the positive polarity decoder or an output of the negative polarity decoder, in response to a polarity control signal (POL). The positive polarity decoder decodes the pixel data RGB DATA received from the second latch array 223 and outputs a positive gamma compensation voltage VGH corresponding to a gray value of the pixel data RGB DATA. The negative polarity decoder decodes the pixel data RGB DATA received from the second latch array 223 and outputs a negative gamma compensation voltage VGL corresponding to the gray value of the pixel data RGB DATA. The multiplexer selects a positive gamma compensation voltage VGH or a negative gamma compensation voltage VGL, in response to the polarity control signal POL.

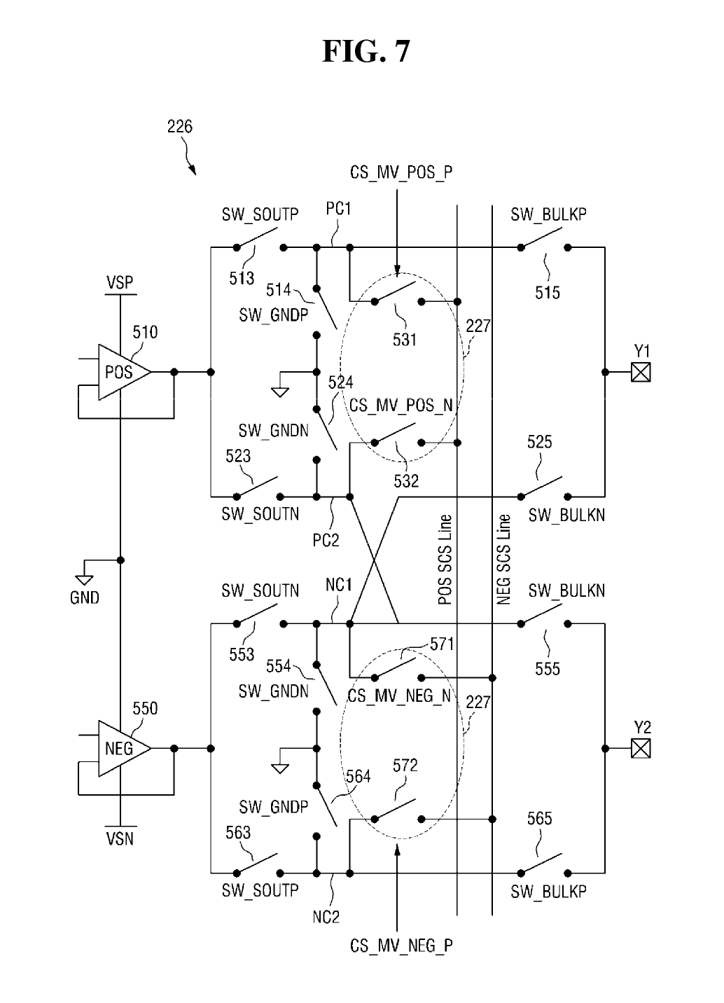

The buffer circuit 226 includes a plurality of output buffers. For example, the output buffers may minimize the signal attenuation of an analog data voltage that is supplied from the DAC 225. The buffer circuit 226 receives a plurality of switching signals (SW) and selectively outputs data voltages to channels. An example of the buffer circuit 226 is described with reference to FIG. 7. The switching signals SW may include, for example, SW_SOUTP, SW_BULKP, SW_GNDN, SW_SOUTN, SW_BULKN, SW_GNDP, and the like, of FIG. 7.

The charge sharing controller 230 receives a plurality of pixel data RGB DATA. For example, the charge sharing controller 230 may determine whether to perform channel charge sharing by analyzing a plurality of first pixel data (or previous pixel data) and a plurality of second pixel data (or current pixel data) following the first pixel data. In this example, the first pixel data may correspond to a first line (a first data line), and the second pixel data may correspond to a second line (a second data line) that is immediately following the first line.

The charge sharing controller 230 may classify the second pixel data into a plurality of transition types based on the first pixel data and the second pixel data. The charge sharing controller 230 may calculate one or more characteristic values indicating characteristics of each transition type and determine whether to perform channel charge sharing based on the characteristic values. Also, the charge sharing controller 230 may generate a charge sharing signal CS based on the determination. The charge sharing signal CS may include CS_MV_POS-P, CS_MV_POS_N, CS_MV_NEG_P, CS_MV_NEG_N, etc. of FIG. 7.

In this example, a transition type may indicate whether the gray value of the current pixel data increases from the gray value of the previous pixel data. For example, a rising type may be used to indicate that the gray value of the current pixel data increases from the gray value of the previous pixel data, a falling type may be used to indicate that the gray value of the current pixel data decreases from the gray value of the previous pixel data, and a no-transition type may be used to indicate that the gray value of the current pixel data and the gray value of the previous data are the same.

The polarity may also be taken into consideration when the second pixel data is classified into a plurality of transition types. For example, the transition types may include a rising type of a first polarity (e.g., the positive polarity), a falling type of the first polarity, a rising type of a second polarity (e.g., the negative polarity), and a falling type of the second polarity.

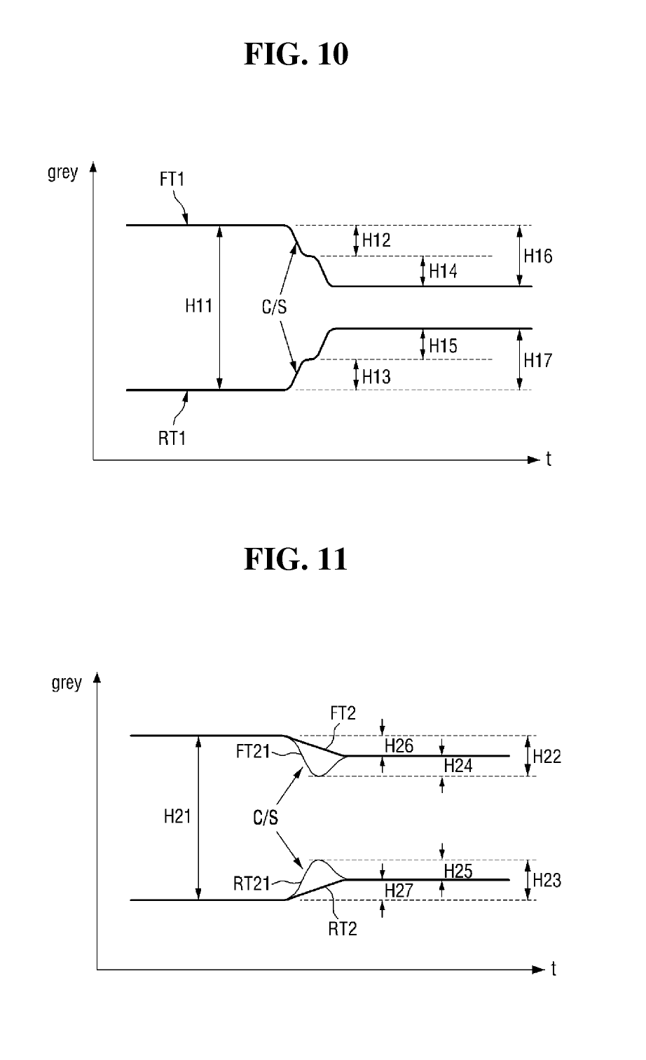

For example, whether to perform charge sharing may be determined based on a transition value of each of the transition types. As another example, whether to perform charge sharing may be determined based on the number of second pixel data corresponding to each of the transition types. As another example, whether to perform charge sharing may be determined based on the first pixel data corresponding to the second pixel data corresponding to each of the transition types. Examples of performing the determination are described with reference to Table 1 and FIGS. 10 through 15.

Charge sharing may cause a plurality of channels having the same polarity to short-circuit. For example, a plurality of channels (or all channels) having the first polarity (e.g., the positive polarity) may electrically short-circuit, and a plurality of channels (or all channels) having the second polarity (e.g., the negative polarity) may electrically short-circuit. Also, charge sharing may be simultaneously performed by three or more channels.

The charge sharing circuit 227 receives the charge sharing signal CS and selectively performs charge sharing.

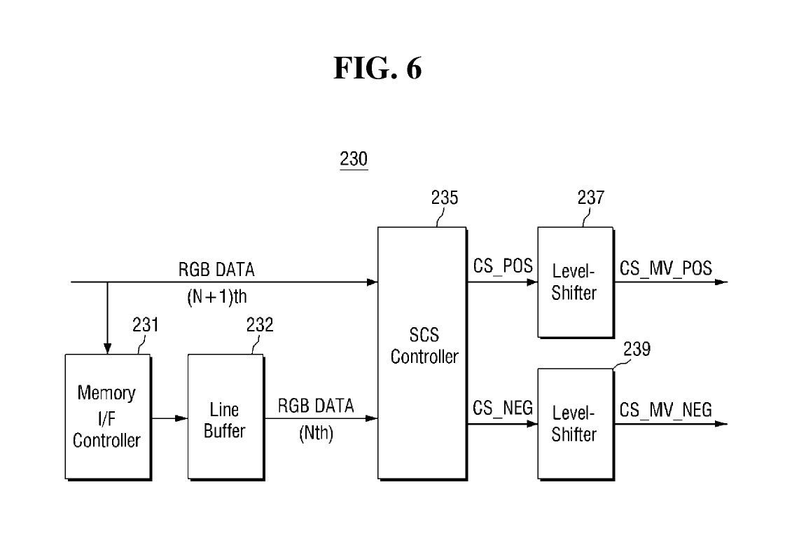

FIG. 6 is a block diagram of the charge sharing controller 230 illustrated in FIG. 5 according to an exemplary embodiment.

Referring to FIG. 6, the charge sharing controller 230 includes a memory interface controller 231, a line buffer 232, a smart charge sharing (SCS) controller 235, and first and second level shifters 237 and 239.

The memory interface controller 23 receives pixel data RGB DATA and stores the pixel data RGB DATA in the line buffer 232. For example, the line buffer 232 may store previous pixel data, that is, a plurality of first pixel data corresponding to a previous line.

The SCS controller 235 receives current pixel data such as a plurality of second pixel data corresponding to a current line, and receives the previous pixel data RGB DATA from the line buffer 232. The SCS controller 235 classifies the second pixel data into a plurality of transition types based on the first pixel data and the second pixel data. In addition, the SCS controller 235 calculates one or more characteristic values indicating characteristics of each transition type and determines whether to perform channel charge sharing based on the characteristic values.

The transition types may include a rising type and a falling type. For example, the characteristic values may include a first transition value of the rising type and a second transition value of the falling type. If the first transition value is greater than a first reference value and if the second transition value is greater than a second reference value, the SCS controller 235 may determine to perform charge sharing.

As another example, the characteristic values may include a first number of second pixel data corresponding to the rising type and a second number of second pixel data corresponding to the falling type. If the first number is greater than a third reference value and if the second number is greater than a fourth reference value, the SCS controller 235 may determine to perform charge sharing.

As another example, the characteristic values may include a first average of first pixel data corresponding to second pixel data of the rising type and a second average of first pixel data corresponding to second pixel data of the falling type. If a value obtained by subtracting the first average from the second average is greater than a fifth reference value, the SCS controller 235 may determine to perform charge sharing.

Also, the above reference values (i.e., the first through fifth reference values) may be configurable.

Polarity (i.e., the positive polarity or the negative polarity) may be reflected in the transition types. For example, the transition types may include a first rising type of the first polarity, a first falling type of the first polarity, a second rising type of the second polarity, and a second falling type of the second polarity.

Based on the determination result about whether to perform charge sharing, the SCS controller 235 may provide a first pre-signal CS_POS associated the first polarity and a second pre-signal CS_NEG associated with the second polarity.

The first level shifter 237 receives and levels the first pre-signal CS_POS and generates a first charge sharing signal CS_MV_POS. The second level shifter 239 receives and levels the second pre-signal CS_NEG and generates a second charge sharing signal CS_MV_NEG.

FIG. 7 is an exemplary circuit diagram of the buffer circuit 226 and the charge sharing circuit 227 illustrated in FIG. 5 according to an exemplary embodiment.

Referring to FIG. 7, the buffer circuit 226 includes an output buffer 510 of the first polarity and an output buffer 550 of the second polarity. In addition, the buffer circuit 226 includes a plurality of switches 513 through 515, 523 through 525, 553 through 555, and 563 through 565. The charge sharing circuit 227 also includes a plurality of switches 531, 532, 571, and 572.

Specifically, the switches 513 through 515, 523 through 525, 553 through 555, 563 through 565, 531, 532, 571 and 572 include a first set of switches that are associated with the first polarity and a second set of switches that are associated with the second polarity. In this example, the first set includes the switches 513, 515, 524, 554, 563, 565, 531 and 572, and the second set includes the switches 523, 525, 514, 564, 553, 555, 532 and 571. The first set and the second set may operate alternately.

The first set operates in a first active section (i.e., a first frame section). In this example, the switching signals SW_SOUTP and SW_BULKP turn on the switches 513, 515, 563 and 565. Therefore, an output of the first output buffer 510 is output to a first pad Y1, and an output of the second output buffer 550 is output to a second pad Y2. Here, the switching signal SW_GNDN turns on the switches 524 and 554. Accordingly, a ground voltage may be applied to input terminals of the switches 525 and 555 in an order that does not exceed a breakdown voltage BV of a medium voltage (MV) element.

The second set operates in a second active section (i.e., a second frame section). In this example, the switching signals SW_SOUTN and SW_BULKN turn on the switches 523, 525, 553 and 555. Therefore, an output of the first output buffer 510 is output to the second pad Y2, and an output of the second output buffer 550 is output to the first pad Y1. In addition, the switching signal SW_GNDP turns on the switches 514 and 564. Accordingly, the ground voltage may be applied to input terminals of the switches 514 and 564 in an order that does not exceed the breakdown voltage BV of the medium voltage (MV) element.

In a horizontal blank section (a section between gate lines), charge sharing may be selectively performed. When charge sharing is performed in the first frame section in which the first set operates, a first charge sharing signal CS_MV_POS_P electrically connects a channel PC1 and a first charge sharing line POS SCS Line, and a second charge sharing signal CS_MV_NEG_P electrically connects a channel NC2 and a second charge sharing line NEG SCS Line.

When charge sharing is performed in the second frame section in which the second set operates, a first charge sharing signal CS_MV_POS_N electrically connects a channel PC2 and the first charge sharing line POS SCS Line, and a second charge sharing signal CS_MV_NEG_N electrically connects a channel NC1 and the second charge sharing line NEG SCS Line.

In this example, the first charge sharing line POS SCS Line is connected to channels (at least three channels) connected to a plurality of output buffers having the first polarity. The second charge sharing line NEG SCS Line is also connected to channels (at least three channels) connected to a plurality of output buffers having the second polarity.

In a vertical blank section (a section between frames), the switching signals SW_GNDP and SW_GNDN may apply the ground voltage to the channels PC1, PC2, NC1 and NC2.

An example of a display method is described with reference to FIGS. 2 and 8 through 15.

Referring to FIG. 2, it is assumed that the entire display panel 1100 capable of performing zigzag inversion displays only a red color. In this example, as the gate line GL1 is activated, pixel data corresponding to a gray level of 255 may be input to the pixel PX1, as the gate line GL2 is activated, pixel data corresponding to a gray level of 0 should be input to the pixel PX4, and as the gate line GL3 is activated, the pixel data corresponding to the gray level of 255 should be input to the pixel PX5. Therefore, an output buffer which applies a data voltage to the data line DL2 may repeatedly generate a data voltage corresponding to the gray level of 255 and a data voltage corresponding to the gray level of 0. That is, the dynamic power consumption of the output buffer may become very high.

According to various exemplary embodiments, a display driver may perform smart charge sharing in order to reduce dynamic power consumption. For example, when high dynamic power consumption is required as in the above example, charge sharing may be performed to reduce dynamic power consumption.

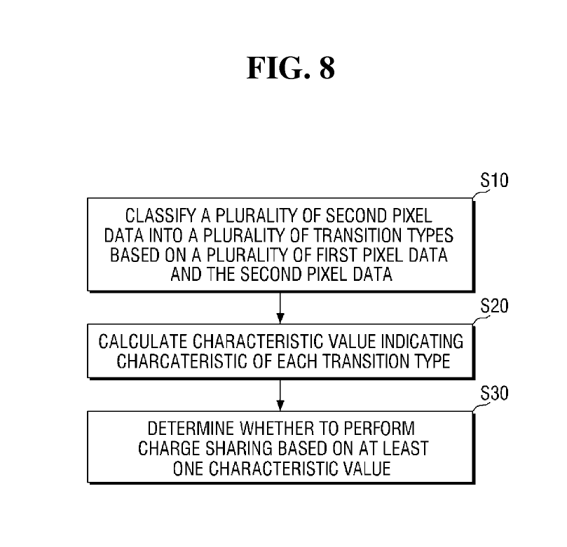

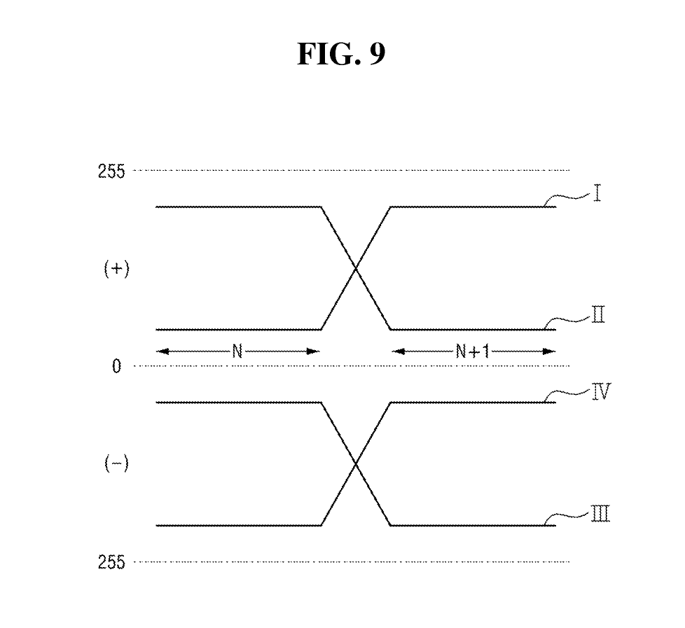

FIG. 8 is a flowchart illustrating a display method according to an exemplary embodiment. FIG. 9 is a conceptual diagram illustrating transition types according to an exemplary embodiment. FIGS. 10 through 13 are conceptual diagrams illustrating a method of determining whether to perform charge sharing according to exemplary embodiments.

Referring to FIG. 8, the display panel 1100 (see FIG. 1) includes k data lines DL1 through DLk. For example, when a previous gate line GL1 is activated, k previous pixel data (i.e., first pixel data) may be simultaneously loaded to the k data lines DL1 through DLk. Then, when a current gate line GL2 is activated, k current pixel data (i.e., second pixel data) is simultaneously loaded to the k data lines DL1 through DLk.

The second pixel data is classified into a plurality of transition types based on the first pixel data and the second pixel data (operation S10).

As an example, referring to FIG. 9 and Table 1, the transition types may include a first type I (a rising type of a first polarity), a second type II (a falling type of the first polarity), a third type III (a rising type of a second polarity), and a fourth type IV (a falling type of the second polarity). For ease of description, only four types are described. However, the second pixel data may be classified into various other transition types.

For example, among the k second pixel data that are loaded when the current gate line GL2 is activated, the number of second pixel data corresponding to the first polarity may be a, and the number of second pixel data corresponding to the second polarity may be b.

Among the a second data corresponding to the first polarity, second pixel data that has a gray value (i.e., a current gray value) that is greater than a previous gray value (i.e., a gray value of the first pixel data) is classified as the first type I, and second pixel data that has a gray value (i.e., the current gray value) that is smaller than the previous gray value is classified as the second type II. Among the a second data, n1 may correspond to the rising type of the first polarity (the first type I), and n2 may correspond to the falling type of the first polarity (the second type II).

Similarly, among the b second data corresponding to the second polarity, second pixel data that has a gray value (i.e., a current gray value) that is greater than a previous gray value (i.e., a gray value of the first pixel data) is classified as the third type III, and second pixel data that has a gray value (i.e., the current gray value) that is smaller than the previous gray value is classified as the fourth type IV. Among the b second data, m1 may correspond to the rising type of the second polarity (the third type III), and m2 may correspond to the falling type of the second polarity (the fourth type IV).

Each transition value shown in Table 1 is a obtained by subtracting a gray value (e.g., 100) of a previous line from a gray value (e.g., 120) of a current line.

Referring again to FIG. 8, a characteristic value indicating a characteristic of each transition type is calculated (operation S20). For example, the characteristic value may be an average value (avg1 through avg6, avg11 through avg16). Referring to Table 1, avg1, avg2, and avg3 respectively indicate an average of first pixel data corresponding to second pixel data, corresponding to the rising type of the first polarity, an average of the second pixel data corresponding to the rising type of the first polarity, and an average of transition values of the second pixel data corresponding to the rising type of the first polarity.

In addition, avg4, avg5, and avg6 respectively indicate an average of first pixel data corresponding to second pixel data corresponding to the falling type of the first polarity, an average of the second pixel data corresponding to the falling type of the first polarity, and an average of transition values of the second pixel data corresponding to the falling type of the first polarity

Further, avg11, avg12, avg13, avg14, avg15 and avg16 are average values calculated for the second polarity in the same way that avg1, avg2, avg3, avg4, avg5, and avg6 are calculated, respectively.

In Table 1, average values are used as an example for ease of description. However, as another example, weighted average values or median values may also be used.

In addition, the characteristic value may be a number of second pixel data corresponding to each transition type. For example, the characteristic value may be n1, n2, m1, or m2 as described above.

TABLE 1

| | | N | N + 1 | |
|---|---|---|---|---|
| | | (previous line) | (current line) | Transition |
| Type | | Gray value | Gray value | value |
| First type | Rising type of | 100 | 120 | 20 |
| (I) | first polarity | 130 | 150 | 20 |
| | (n1) | . . . | . . . | . . . |
| | Average | avg1 | avg2 | avg3 |
| Second type | Falling type of | 200 | 100 | −100 |
| (II) | first polarity | 150 | 130 | −20 |
| | (n2) | . . . | . . . | . . . |
| | Average | avg4 | avg5 | avg6 |
| Third type | Rising type of | 100 | 120 | 20 |
| (III) | second polarity | 130 | 150 | 20 |
| | (m1) | . . . | . . . | . . . |
| | Average | avg11 | avg12 | avg13 |
| Fourth type | Falling type of | 200 | 100 | −100 |
| (IV) | second polarity | 150 | 130 | −20 |
| | (m2) | . . . | . . . | . . . |
| | Average | avg14 | avg15 | avg16 |

Referring again to FIG. 8, whether to perform channel charge sharing based on at least one characteristic value is determined (operation S30). Here, channel charge sharing may cause a plurality of channels having the same polarity to short-circuit. For example, a plurality of channels (or all channels) that have the first polarity (e.g., the positive polarity) may electrically short-circuit, and a plurality of channels (or all channels) that have the second polarity (e.g., the negative polarity) may electrically short-circuit.

An example of a method of determining whether to perform channel charge sharing is described with respect to FIGS. 10 through 13. While FIGS. 10 through 13 are described using a plurality of channels that have the first polarity, the same description may apply to a plurality of channels that have the second polarity.

For example, referring to FIG. 10, a falling type FT1 of the first polarity may fall by H16. For example, a gray value (i.e., avg4 of Table 1) of a previous line and a gray value (i.e., avg5 of Table 1) of a current line may be different from each other by a transition value (i.e., avg6 of Table 1 or H16).

A rising type RT1 of the first polarity may rise by H17. For example, a gray value (i.e., avg1 of Table 1) of a previous line and a gray value (i.e., avg2 of Table 1) of a current line may be different from each other by a transition value (i.e., avg3 of Table 1 or H17)

In addition, a difference between the gray value avg4 of the previous line of the falling type FT1 and the gray value avg1 of the previous line of the rising type RT1 may be H11 (=avg4−avg1).

If charge sharing (C/S) is performed before current pixel data (i.e., second pixel data) is provided to the channels (or data lines), the falling type FT1 falls by H12, and the rising type RT1 rises by H13. Therefore, the falling type FT1 needs to be changed or adjusted by only H14 to have a gray value that corresponds to the current pixel data. In addition, the rising type RT1 needs to be changed by only H15 to have a gray value corresponding to the current pixel data. Accordingly, because an output buffer has to only consume the amount of power for the changes by H14 and H15, dynamic power consumption can be reduced.

Consequently, if the rising type RT1 and the falling type FT1 are as illustrated in FIG. 10, it is desirable to perform charge sharing.

Referring to FIG. 11, a falling type FT2 of the first polarity may fall by, e.g., H26 (=avg6), and a rising type RT2 of the first polarity may rise by, e.g., H27 (=avg3).

In addition, a difference between a gray value avg4 of a previous line of the falling type FT2 and a gray value avg1 of a previous line of the rising type RT2 may be H21 (=avg4−avg1).

In an example in which H26 and H27 are small as illustrated in FIG. 11, charge sharing may not be performed. If charge sharing is performed, a falling type FT21 falls by H22, and a rising type RT21 rises by H23. If charge sharing is not performed, the falling type FT2 should fall only by H26. However, if charge sharing is performed, the falling type FT21 should fall by H22 and then rise by H24. In addition, if charge sharing is not performed, the rising type RT2 should rise only by H27. However, if charge sharing is performed, the rising type RT21 should rise by H23 and then fall by H25. Therefore, if H26 (=avg6) and H27 (=avg3) are smaller than a reference value, charge sharing may be skipped. Because the output buffer may consume more energy to perform charge sharing, charge sharing may not be performed in the case of FIG. 11.

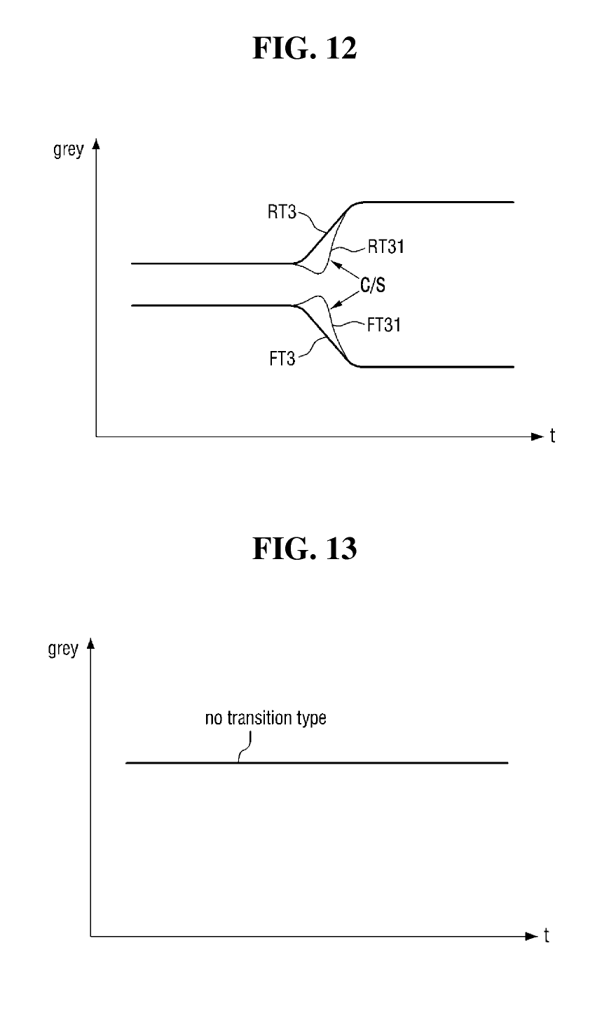

Referring to FIG. 12, when a gray value avg1 of a previous line of a rising type RT3 is greater than a gray value avg4 of a previous line of a falling type FT3, charge sharing may not be performed. However, if charge sharing is performed, a rising type RT31 should fall and then rise, and a falling type FT31 should rise and then fall. Therefore, the output buffer may consume more energy to perform charge sharing. For this reason, charge sharing is not necessary in the example of FIG. 12.

Referring to FIG. 13, charge sharing is unnecessary in an example of the no-transition type (not the rising type or the falling type) determined based on the first pixel data and the second pixel data.

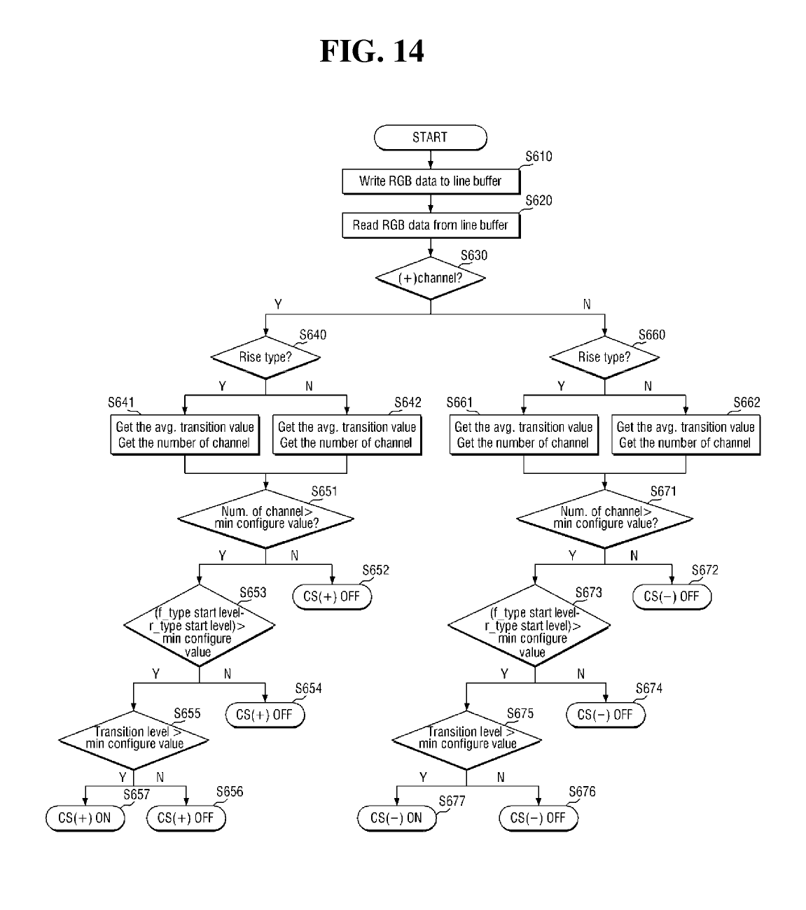

FIG. 14 is a flowchart illustrating a display method according to an exemplary embodiment. For simplicity, a description of features and aspects substantially identical to those described above with reference to FIGS. 6 through 13 is omitted.

Referring to FIG. 14, the memory interface controller 231 writes previous pixel data to the line buffer 232 (see FIG. 6) (operation S610).

The SCS controller 235 reads the previous pixel data from the line buffer 232 (operation S620). The SCS controller 235 also receives current pixel data.

Whether the current pixel data has a first polarity (e.g., a positive polarity (+)) is determined (operation S630).

If the current pixel data has the first polarity, a determination in made as to whether the current pixel data corresponds to a rising type based on the previous pixel data and the current pixel data (operation S640).

An average (i.e., avg3 of Table 1) of the transition values of the current pixel data corresponding to the rising type and a first number (i.e., n1 of Table 1) of channels corresponding to the rising type are calculated (operation S641).

An average (i.e., avg6 of Table 1) of the transition values of the current pixel data corresponding to the falling type and a second number (i.e., n2 of Table 1) of channels corresponding to the falling type are calculated (operation S642).

Next, a determination is made as to whether the number of channels is greater than a minimum reference value (operation S651). For example, a determination may be made as to whether the first number of channels corresponding to the rising type is greater than a third reference value and whether the second number of channels corresponding to the falling type is greater than a fourth reference value. The third reference value and the fourth reference value may be configurable values. In some examples, the third reference value and the fourth reference value may be the same value or they may be different values.

If the first number is smaller than the third reference value, and if the second number is smaller than the fourth reference value, charge sharing is not performed (operation S652). Charge sharing may not be performed in this example because the effect of charge sharing may be obtained only when the first number and the second number are sufficiently large.

Next, a determination is made as to whether a value obtained by subtracting a start level of the rising type (i.e., a gray value (i.e., avg1) of a previous line) from a start level of the falling type (i.e., a gray value (i.e., avg4) of a previous line) is greater than a minimum reference value (operation S653). For example, whether a difference (avg4−avg1) between avg4 and avg1 is greater than a fifth reference value may be determined. The fifth reference value may be a configurable value.

If the difference (avg4−avg1) between avg4 and avg1 is smaller than the fifth reference value, charge sharing is not performed (operation 654). As described above in the example of FIG. 12, if the difference (avg4−avg1) between avg4 and avg1 is smaller than the fifth reference value, the rising type falls and then rises, and the falling type rises and then falls.

Whether a transition value is greater than a minimum reference value is determined (operation S655). That is, whether a first transition value (i.e., avg3 of Table 1) is greater than a first reference value and whether a second transition value (i.e., avg6 of Table 1) is greater than a second reference value is determined. The first reference value and the second reference value are configurable values. For example, the first reference value and the second reference value may be the same.

If the first transition value is smaller than the first reference value and if the second transition value is smaller than the second reference value, charge sharing is not performed (operation S656). As described above in the example of FIG. 11, charge sharing is not performed if the first transition value or the second transition value is small.

Accordingly, if the first transition value is greater than the first reference value and if the second transition value is greater than the second reference value, charge sharing is performed (operation S657).

In summary, charge sharing may be performed if there are a sufficiently large number of channels corresponding to the rising type or the falling type, if the start level of the falling type is sufficiently higher than that of the rising type, and if the transition value is sufficiently large.

Also, if the current pixel data has the second polarity, operations substantially similar to operations S641 through S656 may be performed. For example, if the current pixel data has the second polarity, whether the current pixel data corresponds to the rising type may be identified based on the previous pixel data and the current pixel data (operation S660).

Next, an average (i.e., avg13 of Table 1) of the transition values of the current pixel data corresponding to the rising type and a third number (i.e., m1 of Table 1) of channels corresponding to the rising type are calculated (operation S661).

An average (i.e., avg16 of Table 1) of the transition values of the current pixel data corresponding to the falling type and a fourth number (i.e., m2 of Table 1) of channels corresponding to the falling type are calculated (operation S662).

Also, a determination is made as to whether the number of channels is greater than a minimum reference value (operation S671). For example, whether the third number of channels corresponding to the rising type is greater than an eighth reference value and whether the fourth number of channels corresponding to the falling type is greater than a ninth reference value may be determined. The eighth reference value and the ninth reference value are configurable values. For example, the eighth reference value and the ninth reference value may be the same.

If the third number is smaller than the eighth reference value and if the fourth number is smaller than the ninth reference value, charge sharing is not performed (operation S672). In this example, charge sharing may not be performed because the effect of charge sharing may be obtained only when the third number and the fourth number are sufficiently large.

Next, a determination is made as to whether a value obtained by subtracting a start level of the rising type (i.e., a gray value (i.e., avg11) of a previous line) from a start level of the falling type (i.e., a gray value (i.e., avg14) of a previous line) is greater than a minimum reference value (operation S673). For example, a determination may be made as to whether a difference (avg14−avg11) between avg14 and avg11 is greater than a tenth reference value. The tenth reference value is a configurable value.

If the difference (avg14−avg11) between avg14 and avg11 is smaller than the tenth reference value, charge sharing is not performed (operation 674).

Next, a determination is made as to whether a transition value is greater than a minimum reference value (operation S675). For example, whether a third transition value (i.e., avg13 of Table 1) is greater than a sixth reference value and whether a fourth transition value (i.e., avg16 of Table 1) is greater than a seventh reference value may be determined. The sixth reference value and the seventh reference value are configurable values. For example, the sixth reference value and the seventh reference value may be the same.

If the third transition value is smaller than the sixth reference value and if the fourth transition value is smaller than the seventh reference value, charge sharing is not performed (operation S676).

However, if the third transition value is greater than the sixth reference value and if the fourth transition value is greater than the seventh reference value, charge sharing is performed (operation S677).

Accordingly, charge sharing may be performed if there are a sufficiently large number of channels corresponding to the rising type or the falling type, if the start level of the falling type is sufficiently higher than that of the rising type, and if the transition value is sufficiently large.

In FIG. 14, three criteria are used to determine whether to perform charge sharing. That is, in FIG. 14 the number of channels, the start level, and the transition values are used to determine whether to perform charge sharing. However, not all of the three criteria may to be used. As another example, only one of the three criteria may be used. For example, only a transition value may be used to determine whether to perform charge sharing, or a transition value and a number of channels may be used. As another example, a transition value and a start level may be used to determine whether to perform charge sharing.

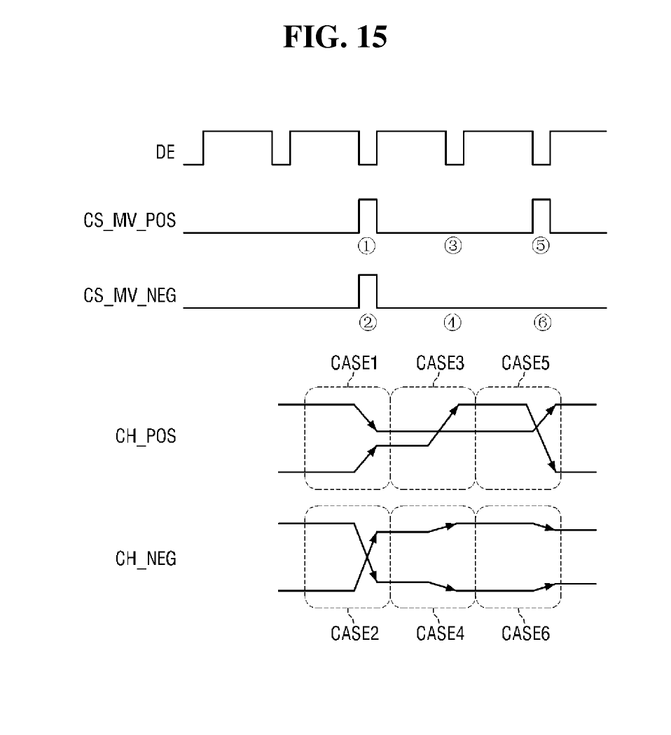

FIG. 15 is a timing diagram illustrating a display method according to another exemplary embodiment. In FIG. 15, an exemplary operation using the display method of FIG. 14 is illustrated.

Referring to FIG. 15, a data enable signal DE is periodically enabled. In this example, while the data enable signal DE is enabled, a plurality of pixel data may be input. On the other hand, while the data enable signal DE is disabled, a first charge sharing signal CS_MV_POS and a second charge sharing signal CS_MV_NEG may be selectively enabled.

In cases 1, 2, and 5, charge sharing is performed if there are a sufficiently large number of channels corresponding to a rising type or a falling type, if a start level of the falling type is sufficiently higher than that of the rising type, and if a transition value is sufficiently large. In this example, the first charge sharing signal CS_MV_POS (see \textcircled{1} and \textcircled{5}) and the second charge sharing signal CS_MV_NEG (see \textcircled{2}) respectively corresponding to case 1, 2, and 5 are enabled.

On the other hand, in case 3, the rising type exists, but the falling type does not exist. For example, the number of channels corresponding to the falling type may be zero. Therefore, the first charge sharing signal CS_MV_POS (see \textcircled{3}) corresponding to case 3 is not enabled.

In case 4, the start level of the falling type is not higher than that of the rising type. Therefore, the second charge sharing signal CS_MV_NEG (see \textcircled{4}) corresponding to case 4 is not enabled.

In addition, in case 6, the transition value is not sufficiently large. For example, a transition value of the falling type is very small, and a transition value of the rising type is very small. Therefore, the second charge sharing signal CS_MV_NEG (see \textcircled{6}) corresponding to case 6 is not enabled.

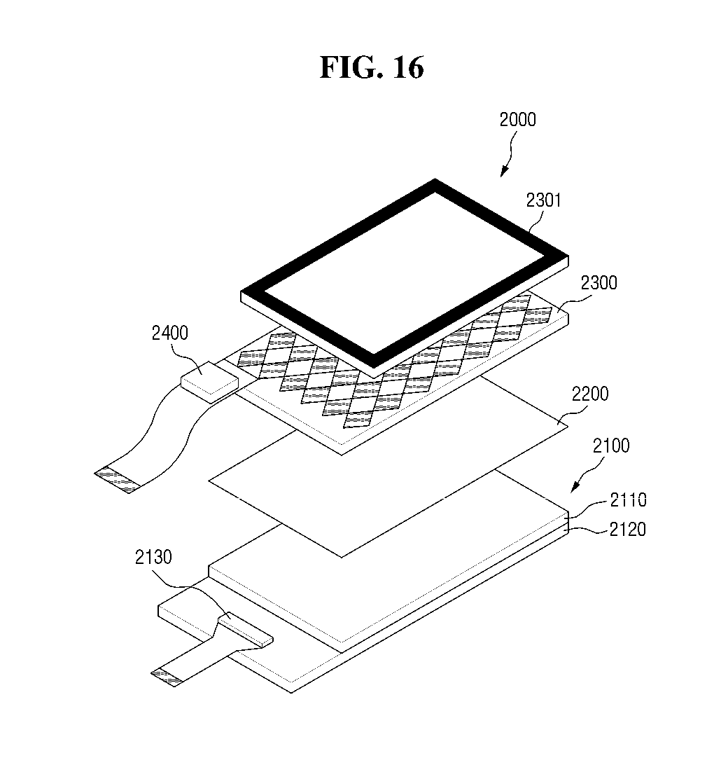

FIG. 16 illustrates a display module 2000 according to an exemplary embodiment.

Referring to FIG. 16, the display module 2000 includes a display device 2100, a polarizer 2200, and a window glass 2301. In this example, the display device 2100 includes a display panel 2110, a printed board 2120, and a display driver chip 2130.

The window glass 2301 is typically made of a material such as acrylic or tempered glass to protect the display module 2000 from an external impact or from scratches due to repeated touches. The polarizer 2200 may improve optical characteristics of the display panel 2110. The display panel 2110 may be patterned as a transparent electrode on the printed board 2120. The display panel 2110 may include a plurality of pixel cells for displaying a frame.

According to one or more exemplary embodiments, the display panel 2110 may be an organic light-emitting diode panel. Each of the pixel cells may include an organic light-emitting diode (OLED) that emits light corresponding to the flow of an electric current. However, the exemplary embodiments are not limited thereto, and the display panel 2110 may include various types of display elements. For example, the display panel 2110 may be an LCD panel, an ECD panel, a DMD panel, an AMD panel, a GLV panel, a PDP, an ELD panel, a light-emitting diode (LED) display panel, a vacuum fluorescent display (VFD) panel, and the like.

The display driver chip 2130 may include the above-described display driver circuit. For example, the display driver chip 2130 may be provided as one chip or a single chip. As another example, a plurality of driver chips may be provided. In addition, the display driver chip 2130 may be mounted on the printed board 2120 in the form of chip-on-glass (COG). As another example, the display driver chip 2130 may be mounted in various forms such as a chip-on-film (COF), a chip-on-board (COB), and the like.

The display module 2000 may further include a touch panel 2300 and a touch controller 2400. For example, the touch panel 2300 may be patterned as a transparent electrode, such as indium tin oxide (ITO), on a glass substrate or a polyethylene terephthalate (PET) film. The touch controller 2400 may sense the occurrence of a touch on the touch panel 2300, calculate coordinates of the touch, and send the calculated coordinates to a host (not illustrated). The touch controller 2400 may be integrated on one semiconductor chip together with the display driver chip 2130.

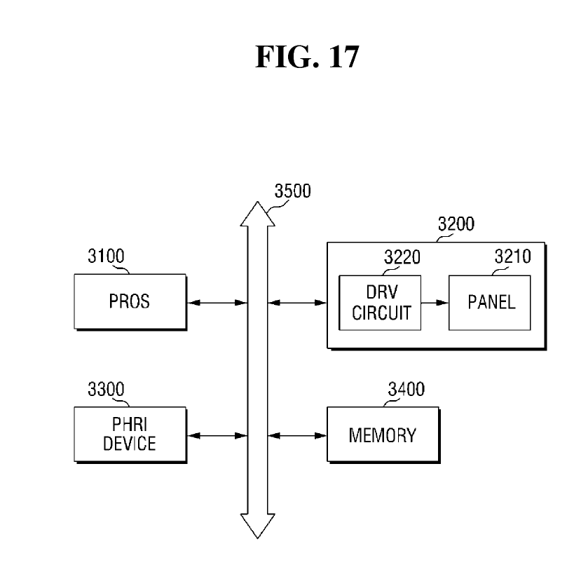

FIG. 17 illustrates a display system according to an exemplary embodiment.

Referring to FIG. 17, the display system includes a processor 3100, a display device 3200, a peripheral device 3300, and a memory 3400 which are electrically connected to a system bus 3500.

The processor 3100 controls data input and output of the peripheral device 3300, the memory 3400, and the display device 3200, and processes images of image data transmitted among the above devices.

The display device 3200 includes a panel 3210 and a driver circuit 3220. For example, the display device 3200 may store image data that is received through the system bus 3500 in a frame memory that is included in the driver circuit 3220 and display the stored image data on the panel 3210. The display device 3200 may be the display device 1000 of FIG. 1. Because the display device 3200 operates asynchronously with the processor 3100, the system load of the processor 3100 may be reduced.

The peripheral device 3300 may be a device (such as a camera, a scanner, a web camera, and the like) which converts a moving image or still image into an electrical signal. In this example, image data obtained by the peripheral device 3300 may be stored in the memory 3400 or displayed on the panel 3210 of the display device 3200, in real time.

The memory 3400 may include a volatile memory element such as a dynamic random access memory (DRAM) and/or a nonvolatile memory element such as a flash memory. In some examples, the memory 3400 may include a DRAM, a phase-change random access memory (PRAM), a magnetic random access memory (MRAM), a resistive random access memory (ReRAM), a ferroelectric random access memory (FRAM), a NOR flash memory, a NAND flash memory, a fusion flash memory (e.g., a combination of an SRAM buffer, a NAND flash memory and a NOR interface logic), and the like. The memory 340 may store image data that is obtained by the peripheral device 3300 and/or store an image signal processed by the processor 3100.

The display system in the example of FIG. 17 may be included in a mobile electronic product such as a smartphone. However, the exemplary embodiments are not limited thereto, and the display system 300 may be included in various types of electronic products that display images.

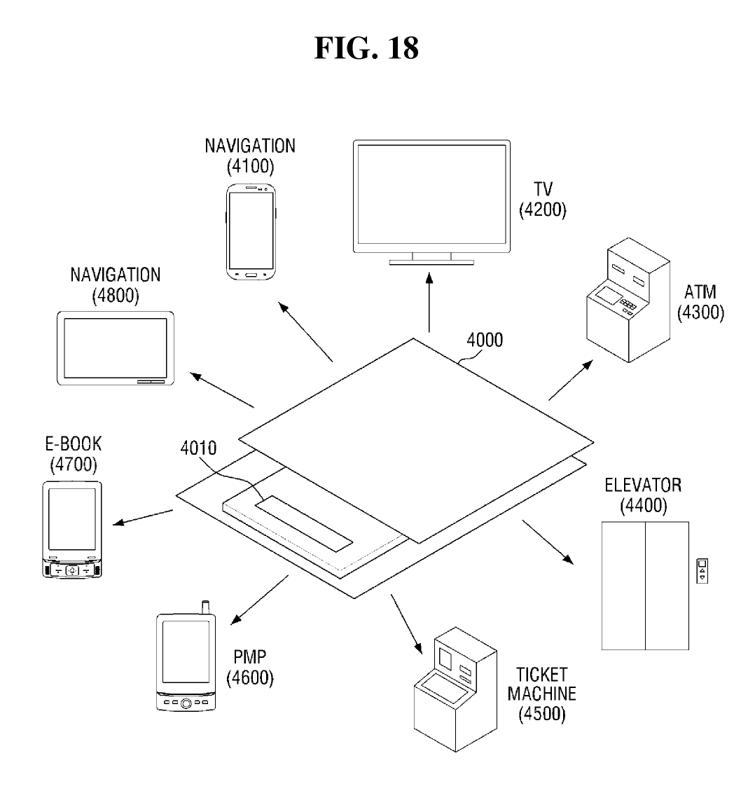

FIG. 18 illustrates various examples of electronic products loaded with a display device 4000 according to various exemplary embodiments.

The display device 4000 of FIG. 18 may be included in various electronic products. For example, the display device 4000 may be used not only in a mobile phone 4100, but also in an automated teller machine (ATM) 4300 which automatically accepts deposits and dispenses cash on behalf of a bank, an elevator 4400, a ticket machine 4500 which is used in subway stations, a portable media player (PMP) 4600, an e-book 4700, a navigation device 4800, and the like.

The display device 4000 may operate asynchronously with a system processor. Therefore, the display device 4000 may reduce the driving load of the processor, thus enabling the processor to operate at high speed with low power consumption. Consequently, the display device 4000 may improve functions of electronic products.

While the present inventive concept has been particularly shown and described with reference to the exemplary embodiments herein, it will be understood by those of ordinary skill in the art that various changes in form and details may be made therein without departing from the spirit and scope of the present inventive concept as defined by the following claims. The exemplary embodiments should be considered in all respects as illustrative and not restrictive, with reference being made to the appended claims rather than the foregoing description to indicate the scope of the inventive concept.

1. A display driver comprising:
a line buffer configured to receive a plurality of first pixel data corresponding to a first line; and
a controller configured to receive a plurality of second pixel data corresponding to a second line that is different from the first line, receive the first pixel data from the line buffer, classify the second pixel data into a plurality of transition types based on the first pixel data and the second pixel data, calculate one or more characteristic values indicating characteristics of each transition type, and determine whether to perform charge sharing of channels based on the characteristic values.

2. The display driver of claim 1, wherein the second line immediately follows the first line.

3. The display driver of claim 1, wherein the plurality of transition types comprise a rising type and a falling type.

4. The display driver of claim 3, wherein the one or more characteristic values comprise a first transition value corresponding to the rising type and a second transition value corresponding to the falling type.

5. The display driver of claim 4, wherein the charge sharing is performed in response to the first transition value being greater than a first reference value, and in response to the second transition value being greater than a second reference value.

6. The display driver of claim 3, wherein the one or more characteristic values comprise a first number of second pixel data corresponding to the rising type and a second number of second pixel data corresponding to the falling type.

7. The display driver of claim 6, wherein the charge sharing is performed in response to the first number being greater than a third reference value and in response to the second number being greater than a fourth reference value.

8. The display driver of claim 3, wherein the one or more characteristic values comprise a first average of first pixel data corresponding to the second pixel data which corresponds to the rising type and a second average of first pixel data corresponding to the second pixel data which corresponds to the falling type.

9. The display driver of claim 8, wherein the charge sharing is performed in response to a value obtained by subtracting the first average from the second average being greater than a fifth reference value.

10. The display driver of claim 1, wherein the plurality of transition types comprise a first rising type having a first polarity, a first falling type having the first polarity, a second rising type having a second polarity, and a second falling type having the second polarity.

11. The display driver of claim 1, wherein the controller is configured to determine whether to perform charge sharing by comparing the one or more characteristic values and a reference value, wherein the reference value is configurable.

12. The display driver of claim 1, wherein the controller is configured to generate a charge sharing signal based on the determination, and the charge sharing signal instructs three or more channels corresponding to the same polarity to share charges.

13. The display driver of claim 1, wherein the plurality of first pixel data and the plurality of second pixel data are applied to a zigzag inversion operation.

14. The display driver of claim 1, wherein the line buffer and the controller are implemented as one integrated circuit chip along with a timing controller.

15. A display driver comprising:
a line buffer that is configured to receive a plurality of first pixel data corresponding to a first line; and
a controller configured to receive a plurality of second pixel data corresponding to a second line that is different from the first line, receive the first pixel data from the line buffer, classify the second pixel data into a plurality of transition types that include a first rising type of a first polarity, a first falling type of the first polarity, a second rising type of a second polarity, and a second falling type of the second polarity, based on the first pixel data and the second pixel data, perform charge sharing of a plurality of channels corresponding to the first polarity in response to a first transition value of the first rising type of the first polarity being greater than a first reference value, and in response to a second transition value of the first falling type of the first polarity being greater than a second reference value, and perform charge sharing of a plurality of channels corresponding to the second polarity in response to a third transition value of the second rising type of the second polarity being greater than a third reference value and in response to a fourth transition value of the second falling type of the second polarity being greater than a fourth reference value.

16. The display driver of claim 15, wherein the controller is configured to perform charge sharing of the channels corresponding to the first polarity in response to the first transition value and the second transition value respectively being greater than the first reference value and the second reference value, a first number of second pixel data corresponding to the first rising type of the first polarity being greater than a fifth reference value, and in response to a second number of second pixel data corresponding to the first falling type of the first polarity being greater than a sixth reference value.

17. The display driver of claim 16, wherein the controller is configured to perform charge sharing of the channels corresponding to the first polarity in response to the first transition value and the second transition value respectively being greater than the first reference value and the second reference value, the first number and the second number respectively being greater than the fifth reference value and the sixth reference value, and in response to a value obtained by subtracting a first average from a second average being greater than a seventh reference value, and
the first average comprises an average of first pixel data corresponding to the second pixel data which correspond to the first rising type of the first polarity, and the second average comprises an average of first pixel data corresponding to the second pixel data which correspond to the first falling type of the first polarity.

18. The display driver of claim 15, wherein the controller is configured to perform charge sharing of the channels corresponding to the second polarity in response to the third transition value and the fourth transition value respectively being greater than the third reference value and the fourth reference value, a third number of second pixel data corresponding to the second rising type of the second polarity being greater than an eighth reference value, and a fourth number of second pixel data corresponding to the second falling type of the second polarity being greater than a ninth reference value.

19. The display driver of claim 18, wherein the controller is configured to perform charge sharing of the channels corresponding to the second polarity in response to the third transition value and the fourth transition value respectively being greater than the third reference value and the fourth reference value, the third number and the fourth number respectively being greater than the eighth reference value and the ninth reference value, and a value obtained by subtracting a third average from a fourth average being greater than a tenth reference value,
wherein the third average comprises an average of first pixel data corresponding to the second pixel data which correspond to the second rising type of the second polarity, and the fourth average comprises an average of first pixel data corresponding to the second pixel data which correspond to the second falling type of the second polarity.

20. The display driver of claim 15, wherein first pixel data input to a first data line from among the plurality of first pixel data corresponds to a first color, and second pixel data input to the first data line from among the plurality of second pixel data corresponds to a second color that is different from the first color.

21-27. (canceled)
